(19) United States
(12) Patent Application Publication
(10) Pub. No.: US 2005/0259697 A1
(43) Pub. Date: Nov. 24, 2005

(54) Raman or erbium-doped fiber laser using few-mode fiber grating, and long-distance remote sensor for simultaneously measuring temperature and strain by separating temperature and strain components using the same

(75) Inventors: Young-Geun Han, Busan (KR); Sang-Bae Lee, Seoul (KR); Sang-Hyuck Kim, Seoul (KR); Ju-Han Lee, Gyeonggi-do (KR)

Correspondence Address: HARNESS, DICKEY & PIERCE, P.L.C., P.O. BOX 828, BLOOMFIELD HILLS, MI, 48303, US

(73) Assignee: Korea Institute of Science and Technology, Seoul (KR)

(21) Appl. No.: 11/024,991

(22) Filed: Dec. 29, 2004

(30) Foreign Application Priority Data
May 24, 2004 (KR) 10-2004-0036808

(51) Int. Cl. H01S 3/30

(52) U.S. Cl. 372/6

(57) ABSTRACT

Disclosed are a Raman or erbium-doped fiber laser using a few-mode fiber grating, and a long-distance remote sensor using the same that can simultaneously measure temperature and strain by separating temperature and strain components using Raman amplification or erbium amplification. When a multi-wavelength Raman or erbium-doped laser is configured by means of a short-period fiber grating serving as a few-mode fiber grating at one side of a resonator and a chirped fiber Bragg grating or tunable chirped fiber Bragg grating at the other side of the resonator, multi-wavelength laser signals are generated in different modes. Because wavelength shift and reflectivity vary with a change in temperature and strain, temperature and strain components can be simultaneously measured. Because an optical fiber of several tens of kilometers is used, it can be utilized as a sensing probe of the long-distance remote sensor.

### BACKGROUND OF THE INVENTION

1. Field of the Invention

The present invention relates to a Raman or erbium-doped fiber laser, and more particularly to a Raman or erbium-doped fiber laser using a few-mode fiber grating that configures a multi-wavelength Raman or erbium-doped fiber laser.

Moreover, the present invention relates to a sensor using a Raman or erbium-doped fiber laser that uses a few-mode fiber grating, and more particularly to a long-distance remote sensor based on a Raman or erbium-doped fiber laser using a few-mode fiber grating that can configure a multi-wavelength Raman or erbium-doped fiber laser using a two-mode fiber grating and that can simultaneously measure temperature and strain by separating temperature and strain components.

2. Description of the Related Art

Optical fibers are well-known as excellent sensors immune to electromagnetic interference. Currently, the optical fibers are variously applied to measure cracks and temperatures of bridges, etc.

The optical fiber sensors can conventionally measure temperature and strain by means of a special optical fiber or multiple fiber gratings. Moreover, conventional long-distance remote sensors based on an optical fiber grating for use in measurement use an ASE (Amplified Spontaneous Emission) light source. In this case, a light signal is transmitted to the optical fiber grating through a long optical fiber. However, there is a problem in that signals sensed from a distance of 25 km or more, that is, temperature and strain signals, cannot be appropriately transmitted due to a Rayleigh scattering phenomenon. Moreover, because of signal noise due to optical-fiber loss and Rayleigh scattering when a conventional broadband light source or ASE of an optical amplifier is used, there is a problem in that it is difficult for a long-distance transmission of a sensor signal to be carried out in a special environment, for example, deep underground or deep underwater.

Because multiple fiber gratings or a special fiber grating must be fabricated for measurement of temperature and strain, there is a problem in that the conventional sensor is complex and inconvenient in use and requires high costs in fabrication thereof.

### SUMMARY OF THE INVENTION

Therefore, the present invention has been made in view of the above and other problems, and it is an object of the present invention to provide a Raman or erbium-doped fiber laser and a long-distance remote sensor that can simultaneously measure temperature and strain by manufacturing an optical fiber grating using a few-mode fiber and manufacturing a multi-wavelength Raman or erbium-doped laser using an optical fiber of several kilometers and that can use a few-mode fiber grating appropriate for long-distance transmission of sensor signals.

In accordance with one aspect of the present invention, the above and other objects can be accomplished by the provision of a Raman or erbium-doped fiber laser using a few-mode fiber grating, comprising: a resonator based on multi-wavelength Raman or erbium amplification using an optical fiber grating with at least two modes.

Preferably, the resonator comprises: an optical fiber serving as a gain medium; a mirror fiber grating formed at one end of the gain medium, the mirror fiber grating being configured by a chirped fiber Bragg grating or tunable chirped fiber Bragg grating of a wide wavelength band for performing a mirror function; and at least one few-mode fiber grating formed at the other end of the gain medium, the few-mode grating being configured by a short-period or variable-period fiber grating for performing a mirror function and a temperature and strain sensing function. Preferably, the optical fiber serving as a Raman gain medium is any one selected from a typical optical fiber, single mode fiber, dispersion shifted fiber, dispersion compensated fiber, PCF (Photonic Crystal Fiber), and HNLF (Highly Nonlinear Fiber). Preferably, the length of the optical fiber serving as the gain medium is selected within the range between several kilometers and several hundred kilometers or more.

In accordance with another aspect of the present invention, the above and other objects can be accomplished by the provision of a long-distance remote sensor for simultaneously measuring temperature and strain by separating temperature and strain components using a Raman or erbium-doped fiber laser that uses a few-mode fiber grating, comprising: a coupler connected to an output stage for receiving Raman laser pumping light; an optical fiber serving as a gain medium extended from the coupler; a mirror fiber grating formed between one end of the gain medium and the coupler, the mirror fiber grating being configured by a chirped fiber Bragg grating or tunable chirped fiber Bragg grating with a wide wavelength band for performing a mirror function; and at least one few-mode fiber grating formed at the other end of the gain medium, the few-mode fiber grating being configured by a short-period or variable-period fiber grating for performing a mirror function and a temperature and strain sensing function. Preferably, the optical fiber serving as a Raman gain medium is any one selected from a typical optical fiber, single mode fiber, dispersion shifted fiber, and dispersion compensated fiber, PCF (Photonic Crystal Fiber), and HNLF (Highly Nonlinear Fiber). Preferably, the length of the optical fiber serving as the gain medium is selected within the range between several kilometers and several hundred kilometers or more.

Preferably, the few-mode fiber grating with several resonant peaks in a wavelength range of the gain medium is repeatedly formed in an extension state so that Raman laser outputs having different wavelengths at different positions can be acquired. Preferably, the few-mode fiber grating is configured so that a center wavelength of the few-mode fiber grating varies with a change in temperature and strain, and a Raman laser's resonance wavelength varies with the few-mode fiber grating's center wavelength and hence the Raman laser's center wavelength varies at the output stage.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a conceptual diagram illustrating a Raman or erbium-doped fiber laser using a few-mode fiber grating and a long-distance remote sensor for simultaneously measuring temperature and strain by separating temperature and strain components using the same in accordance with one embodiment of the present invention;

FIG. 2 is a graph illustrating the optical reflection characteristics of a mirror fiber grating varying with wavelength;

FIG. 3 is a graph illustrating the strain dependence of wavelength;

FIG. 4 is a graph illustrating the temperature dependence of wavelength; and

FIG. 5 is a conceptual diagram illustrating another long-distance remote sensor serving as the sensor shown in FIG. 1.

### DESCRIPTION OF THE PREFERRED EMBODIMENTS

Now, preferred embodiments of the present invention will be described in detail with reference to the annexed drawings.

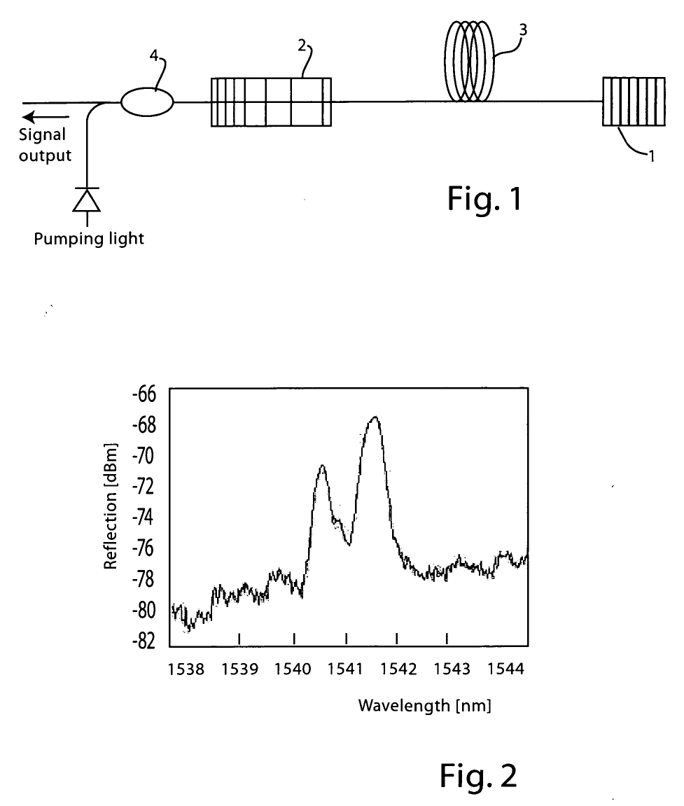

FIG. 1 is a conceptual diagram illustrating a Raman or erbium-doped fiber laser using a few-mode fiber grating, and a long-distance remote sensor for simultaneously measuring temperature and strain by separating temperature and strain components using the same in accordance with one embodiment of the present invention.

Referring to FIG. 1, the long-distance remote sensor for simultaneously measuring temperature and strain by separating temperature and strain components comprises a few-mode fiber grating 1, a chirped fiber Bragg grating or tunable chirped fiber Bragg grating 2, an optical fiber 3, and a wavelength multiplexing coupler 4. The few-mode fiber grating 1 is formed by a short-period fiber grating for sensing temperature and strain changes. The chirped fiber Bragg grating or tunable chirped fiber Bragg grating 2 serves as a mirror fiber grating for configuring a Raman or erbium-doped fiber laser resonator. The optical fiber 3 is any one selected from among a typical optical fiber having a sufficient length necessary for erbium-doped fiber amplification or Raman amplification with a single mode fiber, dispersion shifted fiber, dispersion compensated fiber, PCF (Photonic Crystal Fiber), HNLF (Highly Nonlinear Fiber) and erbium-doped fiber. The wavelength multiplexing coupler 4 transfers laser pumping light to the optical fiber 3.

An output sensor signal is transferred to an output stage through the wavelength multiplexing coupler 4.

Multi-wavelength Raman or erbium-doped fiber laser light is generated between the few-mode fiber grating 1 and the chirped fiber Bragg grating or tunable chirped fiber Bragg grating 2, and varies with a change in temperature and strain.

This embodiment uses Raman or erbium-doped amplification for generating a sensor signal. As shown in FIG. 1, the resonator for laser oscillation comprises: the optical fiber 3 serving as a gain medium having a long length; the single mirror fiber grating 2 performing a mirror function at one end of the gain medium, that is, a chirped fiber Bragg grating or tunable chirped fiber Bragg grating with a wide wavelength band; and the few-mode fiber grating 1 performing a mirror function at the other end of the gain medium for sensing temperature and strain.

Laser pumping light is transferred to the optical fiber 3 serving as the gain medium using the wavelength multiplexing coupler 4. In this case, the optical fiber 3 must have a sufficient length so that Raman or erbium-doped amplification can occur. The length of the optical fiber can be sufficiently extended up to several hundred kilometers or more according to the intensity of the pumping light and the type of optical fiber. When sufficient pumping light is incident inside the resonator, the multi-wavelength Raman or erbium-doped laser generates a multi-wavelength Raman or erbium-doped laser signal. In this case, the few-mode fiber grating 1 varies with a change in temperature and strain. Since resonance wavelengths are different, the multi-wavelength Raman or erbium-doped fiber laser can distinguish temperature and strain components.

When the optical fiber 3 having a long length is placed deep underground or deep underwater, the few-mode fiber grating 1 connected to the end of the optical fiber 3 can simultaneously sense the temperature and strain components.

The few-mode fiber grating 1 is a grating in which a few modes are present. Moreover, the few-mode fiber grating 1 uses a principle in which a center wavelength and a mode vary with a change in temperature and strain. The mirror fiber grating 2 connected to the opposite side of the few-mode fiber grating 1 must have a sufficient wavelength band to cope with a center wavelength change of the sensing fiber grating.

When the center wavelength of the few-mode fiber grating 1 varies with a change in temperature and strain, a resonance wavelength of the multi-wavelength Raman or erbium-doped fiber laser varies and the center wavelength of a multi-wavelength Raman or erbium-doped fiber laser signal serving as an output signal is shifted. Thus, the wavelength shift of output light is measured, such that temperature and strain changes can be measured.

FIG. 2 is a graph illustrating the optical reflection characteristics of the mirror fiber grating varying with wavelength. Referring to FIG. 2, there are shown the optical reflection characteristics of the mirror fiber grating 2 and the few-mode fiber grating 1 used as an example of verifying the principle of the present invention.

Here, as the few-mode fiber grating 1 uses the two-mode fiber grating, it can be seen that laser oscillation at two wavelengths is carried out. The mirror fiber grating 2 has a wavelength width of 5 nm corresponding to a sufficient wavelength width necessary for measuring a temperature change of Celsius 500° C. or more.

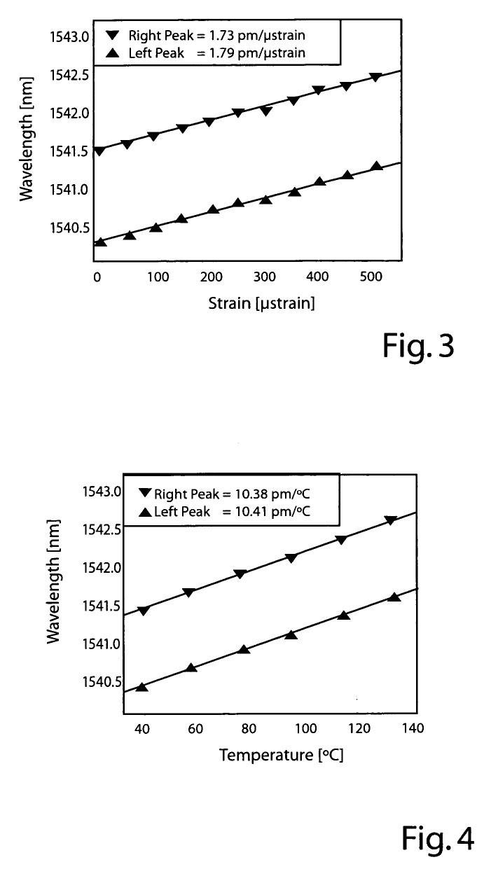

FIG. 3 is a graph illustrating the strain dependence of wavelength; and FIG. 4 is a graph illustrating the temperature dependence of a wavelength. Here, the two-mode fiber grating is used as the few-mode fiber grating. It can be seen that laser oscillation at two wavelengths is carried out, as in FIG. 2. Referring to FIGS. 3 and 4, it can be seen that wavelengths vary with a change in temperature and strain. Two wavelength values, based on a Raman or erbium-doped fiber laser output, linearly increase according to the change in temperature and strain. The strain and temperature dependences of wavelength can be expressed as in the following.

$$( \begin{matrix}Δɛ \\ Δ T\end{matrix} ) = ( \begin{matrix}18.19 & - 18.23 \\ - 3.03 & 3.14\end{matrix} ) ( \begin{matrix}{Δλ}_{B1} \\ {Δλ}_{B2}\end{matrix} )$$

Thus, temperature and strain components can be easily discriminated.

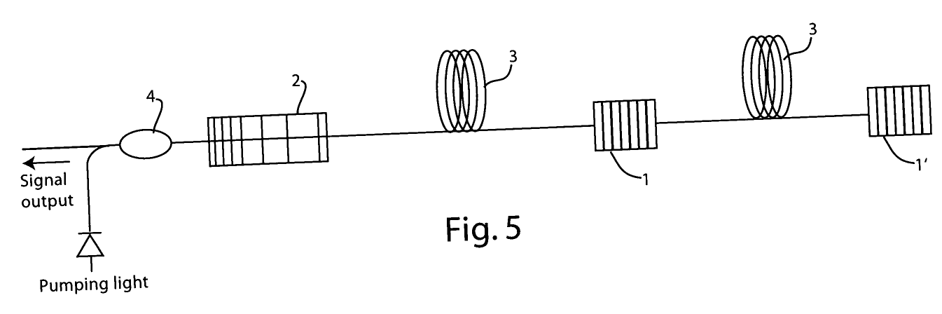

FIG. 5 is a conceptual diagram illustrating another long-distance remote sensor having distributed components serving as the sensor shown in FIG. 1. The sensor structure shown in FIG. 1 can be extended to the long-distance remote sensor shown in FIG. 5. Here, the wavelengths of few-mode fiber gratings 1 and 1′ must be different. It can be seen that multi-wavelength Raman or erbium-doped fiber laser outputs with different wavelengths are enabled at an output stage. When each wavelength change is measured, the temperature and strain at a desired position can be simultaneously measured.

The Raman or erbium-doped fiber laser using a very long optical fiber and optical fiber gratings can be used for measuring the temperature and strain of the deep water or earth.

The present invention has the following functional characteristics.
1. Simultaneous measurement of temperature and strain
2. Multi-wavelength Raman or erbium-doped fiber laser constitution
3. Simplification of an equipment configuration
4. Easy implementation of a long-distance remote sensor (at a distance of several hundred kilometers or more) capable of carrying out measurement deep underwater or deep underground
5. Expansion of a measurement range
6. Cost-effective fabrication and mass production

As apparent from the above description, the present invention provides a Raman or erbium-doped fiber laser using a few-mode fiber grating, and a long-distance remote sensor for simultaneously measuring temperature and strain by separating temperature and strain components using the same that can bring about system simplification, low cost and high performance because a single optical fiber grating is used as a sensor probe, and that can be easily used at a distance of 25 km or more corresponding to a limit point of the conventional sensor technology because a very long optical fiber is used as a gain medium.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A Raman or erbium-doped fiber laser using a few-mode fiber grating, comprising:
a resonator based on multi-wavelength Raman or erbium amplification using an optical fiber grating with at least two modes.

2. The Raman or erbium-doped fiber laser of claim 1, wherein the resonator comprises:
an optical fiber serving as a gain medium;
a mirror fiber grating formed at one end of the gain medium, the mirror fiber grating being configured by a chirped fiber Bragg grating or tunable chirped fiber Bragg grating of a wide wavelength band for performing a mirror function; and
at least one few-mode fiber grating formed at the other end of the gain medium, the few-mode grating being configured by a short-period or variable-period fiber grating for performing a mirror function and a temperature and strain sensing function.

3. The Raman or erbium-doped fiber laser of claim 2, wherein the optical fiber serving as a Raman gain medium is any one selected from a typical optical fiber, single mode fiber, dispersion shifted fiber, dispersion compensated fiber, PCF (Photonic Crystal Fiber), and HNLF (Highly Nonlinear Fiber).

4. The Raman or erbium-doped fiber laser of claim 2, wherein the length of the optical fiber serving as the gain medium is selected within the range between several kilometers and several hundred kilometers or more.

5. A long-distance remote sensor for simultaneously measuring temperature and strain by separating temperature and strain components using a Raman or erbium-doped fiber laser that uses a few-mode fiber grating, comprising:
a coupler connected to an output stage for receiving Raman laser pumping light;
an optical fiber serving as a gain medium extended from the coupler;
a mirror fiber grating formed between one end of the gain medium and the coupler, the mirror fiber grating being configured by a chirped fiber Bragg grating or tunable chirped fiber Bragg grating of a wide wavelength band for performing a mirror function; and
at least one few-mode fiber grating formed at the other end of the gain medium, the few-mode fiber grating being configured by a short-period or variable-period fiber grating for performing a mirror function and a temperature and strain sensing function.

6. The long-distance remote sensor of claim 5, wherein the optical fiber serving as a Raman gain medium is any one selected from a typical optical fiber, single mode fiber, dispersion shifted fiber, dispersion compensated fiber, PCF (Photonic Crystal Fiber), and HNLF (Highly Nonlinear Fiber).

7. The long-distance remote sensor of claim 5, wherein the length of the optical fiber serving as the gain medium is selected within the range between several kilometers and several hundred kilometers or more.

8. The long-distance remote sensor of claim 5, wherein the few-mode fiber grating with several resonant peaks in a wavelength range of the gain medium is repeatedly formed in an extension state so that Raman laser outputs having different wavelengths at different positions can be acquired.

9. The long-distance remote sensor of claim 5, wherein the few-mode fiber grating is configured so that a center wavelength of the few-mode fiber grating varies with a change in temperature and strain, and a Raman laser's resonance wavelength varies with the few-mode fiber grating's center wavelength and hence the Raman laser's center wavelength varies at the output stage.
